(19) United States
(12) Patent Application Publication
(10) Pub. No.: US 2007/0183596 A1
(43) Pub. Date: Aug. 9, 2007

(54) Personal short code translation

(75) Inventor: Yair Winkler, Caesarea (IL)

Correspondence Address: BROWDY AND NEIMARK, P.L.L.C.;624 NINTH STREET, NW, SUITE 300, WASHINGTON, DC, 20001-5303, US

(73) Assignee: Festin Enterprises Corporation, Der Stadt (PA)

(21) Appl. No.: 11/349,983

(22) Filed: Feb. 9, 2006

(51) Int. Cl. H04K 1/00

(52) U.S. Cl. 380/247

(57) ABSTRACT

The present invention relates to a method for setting up a call for a short-code access number dialed out by a mobile terminal, said method comprising the steps of: intercepting said dialed-out short-code access number by software or hardware logic on said mobile terminal, and storing said short-code access number in a temporary buffer; setting up a signaling channel interconnecting said mobile terminal to a predefined communication server; transmitting over said signaling channel the short-code number from said mobile terminal to said communication server; extracting from a short-code access number database the full telephone number equivalent to the transmitted short-code access number; transmitting as a response over said signaling channel the full telephone number equivalent to the previously transmitted short-code access number from said communication server to said mobile terminal; and setting up a voice channel between said mobile terminal and the full telephone number provided by the communication server.

### FIELD OF THE INVENTION

The present invention relates to a telecommunication system and methods to enable a mobile terminal user to conveniently use short-code access numbers while roaming.

### BACKGROUND OF THE INVENTION

Commercial telephone numbers are hard to advertise because it is not easy for users to memorize complete telephone numbers, sometimes with 8, 10 digits or even more.

One solution has consisted in exploring the fact that each phone key from 2 to 9 is also associated with characters printed by the digit. From “abc” associated with the digit 2 to “wxyz” associated with the digit 9. In substituting a digit with one of the 3 characters printed on the same digit, the number 1-800-3673-826 can be advertised as 1-800-FORD-VAN. If the user punches each digit associated with the combination FORD VAN, the number 3673 826 will be dialed. This solution is very limited because it requires companies to get new telephone numbers that would fit exactly with the company name or product. These so-called vanity numbers are also hard to get from operators.

Mobile operators often use short numbers that are easy to promote and to remember. Examples of short numbers are: 123, * 123 or #123. These short numbers—also known as short-code access numbers—are translated by the mobile operator to full telephone numbers. The user dialing the short-code access number may never be aware of what the full telephone number actually is.

While using short-code access numbers is a very convenient way to promote a telephone number to be used by a mobile terminal user, the current implementations do not work seamlessly. One important shortfall of the current implementation of short-codes access numbers is that most of the time, the short-code access numbers work, or work reliably only when the user is within the territory controlled directly by his original mobile operator. When the user is traveling to a different country or region not serviced directly by his mobile operator, a condition known in the telecommunication industry as roaming, the short-code access numbers may not work at all since the short codes are first received by the roaming operator who is not aware of what their real translation is. In an even worse scenario, the same short-code access number used by subscribers of one operator translates to a different service at another operator leading the user to unnecessary phone charges in addition to the inconvenience caused.

Enabling the mobile terminal user to seamlessly use short codes while roaming also requires the service provider to pay attention to the content provided to the mobile user in response. When a user is traveling and calls to check the football scores, it makes sense to connect him with the football service back home. But if a user calls abroad for a taxi service, he must be connected with a local taxi service nearby, and not with a taxi service back home. Thus roaming short-code translation must provide dynamic content based on where the user is calling from, and not only static content.

Current solutions for roaming short-code translation require the mobile operator to sign specific cooperation agreements with each mobile operator counterpart he wishes to work with. In addition, specific infrastructure needs to be implemented at each such cooperating mobile operator. This solution is thus cumbersome and expensive for the mobile operator since he will need to purchase, install and maintain specific infrastructure at each mobile operator with which he would like to have short-code access number translation. This solution is not fully satisfactory to the user since the service coverage for short-code access numbers translation when roaming will not be universal and will not work seamlessly everywhere.

### SUMMARY OF THE INVENTION

The present invention provides a telecommunication system and methods for setting up a call based on a short-code access number dialed out by a mobile terminal. The method comprises the steps of: intercepting the dialed out short-code access number and storing it aside in a temporary buffer; transmitting over a signaling channel the short-code access number to a predefined communication server; receiving from said communication server the corresponding full telephone number extracted from a short-code access number database; and setting up a voice call from the mobile terminal to the received full telephone number.

Currently, short-code access numbers are only available to mobile operators. The present invention allows the service provider to allocate short-code access numbers to different categories of entities. The pool of short-code access numbers allocated to each category of entities can be either random or organized according to usage or commercial criteria. In a more preferred embodiment of the present invention, each separate entity is allocated short-code access numbers with a predefined number of digits.

In one embodiment, a real or virtual mobile operator is allocated short-code access numbers with 3 or 4 digits to be used by all its subscribers. The mobile operator typically offers general-purpose services such as news, directory services, delivery services, voicemail etc.

In another embodiment, companies, commercial organizations and non-commercial organizations are allocated short-code access numbers with 2 digits to be used by their own employees. These short-code access numbers can serve to call company specific locations or services such as a specific office location, the accounting service etc.

In yet another embodiment, individual subscribers are allocated short-code access numbers with a single digit to be used individually. These short-code access numbers can serve either professionally for example to call a customer or a business partner, or serve as private short-codes, for example to call a family member or a friend.

The present invention enables each entity to manage and customize its own short-code access numbers and their full telephone number translations in the short-code access number database.

When the communication server is able to receive information about the geographic location of the mobile terminal either directly from said mobile terminal or from a different source, the translation of a given short-code access number may take into account the geographic location of the mobile terminal in order to provide access to the most relevant service.

### BRIEF DESCRIPTION OF THE FIGURES

FIG. 1 illustrates a block diagram of a telecommunication system of the invention comprising a mobile terminal, and a communication server coupled with its database for short-code access number translation.

FIG. 2 illustrates an embodiment of the invention in which a short-code access number database is segmented into 3 portions for different categories of entities: operators, companies and individual subscribers.

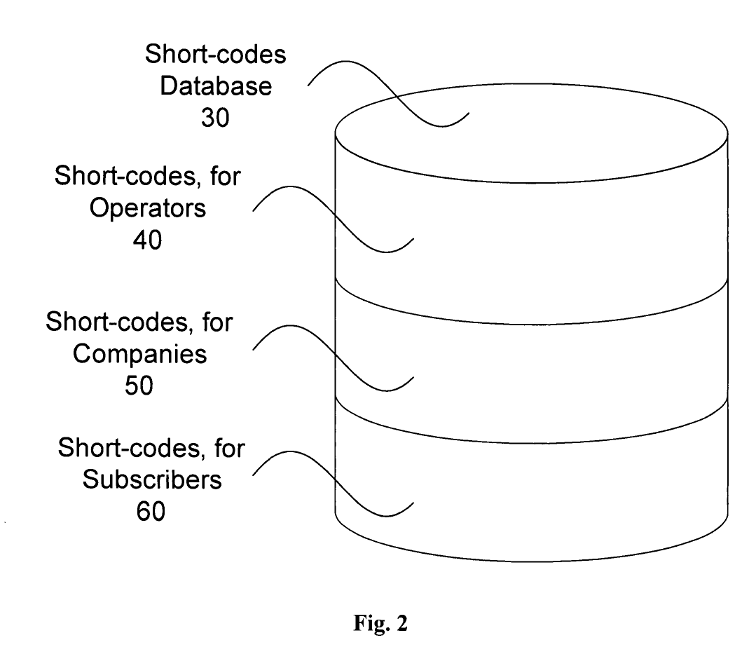

### DETAILED DESCRIPTION OF THE INVENTION

In the following detailed description of various embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The present invention relates to a method for setting up a call for a short-code access number dialed out by a mobile terminal, said method comprising the steps of:

(i) intercepting said dialed-out short-code access number by software or hardware logic on said mobile terminal, and storing said short-code access number in a temporary buffer;

(ii) setting up a signaling channel interconnecting said mobile terminal to a predefined communication server;

(iii) transmitting over said signaling channel the short-code number from said mobile terminal to said communication server;

(iv) extracting from a short-code access number database the full telephone number equivalent to the transmitted short-code access number;

(v) transmitting as a response over said signaling channel the full telephone number equivalent to the previously transmitted short-code access number from said communication server to said mobile terminal; and

(vi) setting up a voice channel between said mobile terminal and the full telephone number provided by the communication server.

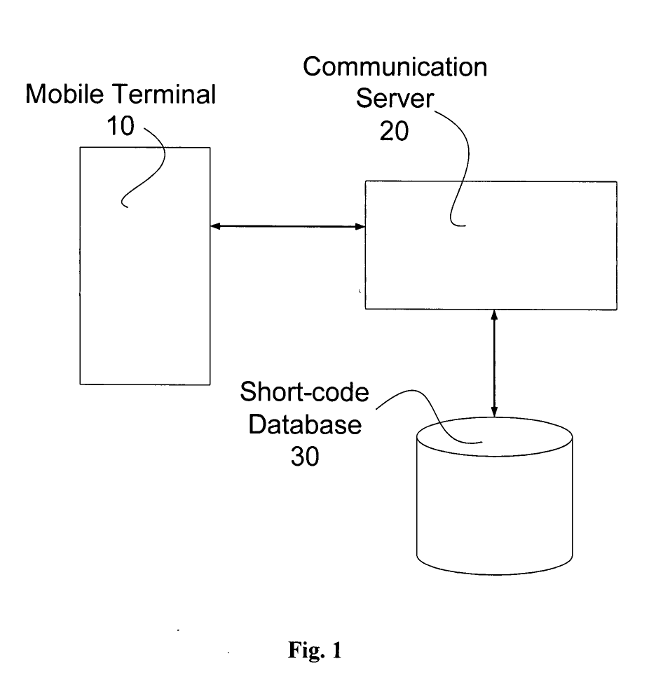

FIG. 1 shows a telecommunication system according to the present invention for the implementation of said method, for setting up a call for a short-code access number dialed out by a mobile terminal 10, wherein said system comprises:

(i) a predefined communication server 20;

(ii) means for transmitting a short-code access number over a signaling channel from said mobile terminal 10 to said communication server 20;

(iii) a database 30 coupled to said communication server 20, wherein said database 30 contains translation information from said short-code access numbers to full telephone numbers;

(iv) means for transmitting said full telephone number over a signaling channel from said communication server 20 to said mobile terminal 10; and

(v) means for setting up a call from said mobile terminal 10 to said full telephone number.

In a preferred embodiment of the present invention, the short-code access number database 30 used for extracting the full telephone numbers of dialed short-code access numbers, is segmented into different portions. Each segment or portion of said database 30 is used by separate categories of entities. Said entities can be different by their legal structure, their commercial behavior or applications, or by any other criteria decided by the operator of the service. Each category of entities is then allocated its own pool of short-code access numbers in either a random order or according to a predefined order following any commercial or usage criteria decided by the service provider. In a more preferred embodiment of the present invention, each category of entities is allocated short-code access numbers with a predefined number of digits.

In another more preferred embodiment of the present invention, one category of entities is composed of real or virtual mobile operators that are allocated operator short-code access numbers 40 with 3 or 4 digits. The majority of short-code access numbers used by mobile operators today contain 3 or 4 digits. Mobile operators use operator short-codes 40 either to promote their own services such as voicemail or directory assistance, or to promote commercial services in cooperation with a 3^{rd} party such as taxi reservations, ticket purchasing or sending flowers.

In another more preferred embodiment of the present invention, another category of entities is composed of companies, commercial organizations, or non-commercial organizations that are allocated company short-code access numbers 50 with 2 digits. These proprietary, company short-code access numbers 50 help companies provide their workers with faster and easier access to specific departments, geographic locations or specific people. Thus, company-specific short-code access numbers 50 can designate within a given company different destinations such as: accounting, technical support, the Paris office, the Tokyo branch, the Director of Sales, or the Public Relations manager.

In yet another preferred embodiment of the present invention, another category of entities is composed of individual subscribers or users that are allocated subscriber short-code access numbers 60 with a single digit. Individual subscribers can use their allocated short-code access numbers 60 for faster and easier access to telephone numbers of their choice. Subscribers can use their short-code access numbers 60 to call their work, home, their wives, a relative, a friend or any other number they call frequently.

In another aspect of the present invention, each entity is provided with means for managing its own pool of short-code access numbers in the database 30. Authorized users for each entity can thus add, modify or remove short-code access numbers and their full telephone number translations.

In still another aspect of the present invention, authorized users for each entity access the short-code access number database 30 via an external network in order to manage their short-code access numbers. Thus a commercial service operator can allow authorized users from each entity to access the short-codes database 30 from a distance via an external network.

The external network used to access the short-codes database 30 can be either a public network or a private network or a combination of both. Network access to the short-code access number database 30 can be achieved via wired or wireless means. In a more preferred embodiment of the present invention, authorized users access the short-codes database 30 via the Internet in order to manage their short-code access numbers.

In another embodiment of the present invention, short-code access numbers are translated to full telephone numbers based on the geographic location of the mobile terminal 10. Services accessed by short-code access numbers can be divided into two categories. The first category consists of static services wherein a given dialed-out short-code access number always translates to a unique telephone number and always reaches the same service. When a user dials a short-code to reach his voicemail, he needs connection to the same voicemail system regardless of where he is located at the moment of call. The second category of services consists of dynamic services wherein a given dialed-out short-code access number will reach a different service depending on the geographic location of the mobile terminal 10. When a user dials a short-code access number for a taxi service, he needs a taxi at his present geographic location. The predefined communication server 20 will thus lookup the translation for the short-code access number for a taxi service in a table of geographic locations, and will translate said taxi service short-code access number to a different telephone number depending on the provided location of the mobile terminal 10.

According to the present invention, the mobile terminal 10 is equipped with specific software or hardware logic in order to set-up the right call for the dialed-out short-code access number. Said software or hardware logic performs the following steps:

(i) intercepting the dialed-out short-code access number, and storing said short-code access number in a temporary buffer;

(ii) setting up a signaling channel interconnecting said mobile terminal 10 to a predefined communication server 20;

(iii) transmitting over said signaling channel the short-code number from said mobile terminal 10 to said communication server 20;

(iv) receiving as a response over said signaling channel from said communication server 20 the full telephone number equivalent to the transmitted short-code access number, said full telephone number extracted from a short-code access number database 30; and

(v) setting up a voice channel between said mobile terminal 10 and the full telephone number provided by the communication server 20.

The software or hardware logic on the mobile terminal 10 can be either built-in or preloaded into the device, typically before the mobile terminal 10 is purchased, or downloaded or upgraded later on. Said logic can be placed within an attached memory device to the mobile terminal 10. In one embodiment of the present invention, said logic is placed in the Subscriber Identification Module (SIM) card.

In another embodiment of the present invention, said software logic is downloaded into the mobile terminal 10 from an external source. The external source can be the Internet, a corporate network, a commercial network, a personal computer or a mobile terminal.

1. A method for setting up a call for a short-code access number dialed-out by a mobile terminal, said method comprising the steps of:
(i) intercepting said dialed-out short-code access number by software or hardware logic on said mobile terminal, and storing said short-code access number in a temporary buffer;
(ii) setting up a signaling channel interconnecting said mobile terminal to a predefined communication server;
(iii) transmitting over said signaling channel the short-code number from said mobile terminal to said communication server;
(iv) extracting from a short-code access number database the full telephone number equivalent to the transmitted short-code access number;
(v) transmitting as a response over said signaling channel the full telephone number equivalent to the previously transmitted short-code access number from said communication server to said mobile terminal; and
(vi) setting up a voice channel between said mobile terminal and the full telephone number provided by the communication server.

2. A method according to claim 1, wherein said database contains short-code access numbers for different categories of entities.

3. A method according to claim 2, wherein short-code access numbers are allocated to each of said different categories of entities according to a predefined order.

4. A method according to claim 3, wherein each of said different categories of entities is allocated short-code access numbers with a predefined number of digits.

5. A method according to claim 2, wherein said categories of entities are selected from the group consisting of: (i) real or virtual mobile operators, (ii) companies, commercial organizations, or non-commercial organizations, (iii) individual subscribers, and (iv) any combination of (i) to (iii).

6. A method according to claim 5, wherein said category of entities is real or virtual mobile operators that are allocated short-code access numbers with 3 or 4 digits.

7. A method according to claim 5, wherein said category of entities is companies, commercial organizations, or non-commercial organizations that are allocated short-code access numbers with 2 digits.

8. A method according to claim 5, wherein said category of entities is individual subscribers that are allocated short-code access numbers with 1 digit.

9. A method according to claim 1, wherein the short-code access number database is updated, managed or modified by authorized users.

10. A method according to claim 9, wherein the short-codes access number database is updated, managed or modified by authorized users via an external interface.

11. A method according to claim 10, wherein the external interface is the Internet.

12. A method according to claim 1, wherein said communication server receives information about the geographic location of said mobile terminal.

13. A method according to claim 12, wherein a given short-code access number is translated into different full telephone numbers depending on the geographic location of said mobile terminal.

14. A method according to claim 1, wherein said software or hardware logic on the mobile terminal is placed within an attached memory device.

15. A method according to claim 14, wherein said attached memory device is a Subscriber Identification Module (SIM) card.

16. A method according to claim 1, wherein said software or hardware logic is downloaded from an external source.

17. A method according to claim 16, wherein said external source is the Internet, a corporate network, a commercial network, a personal computer or a mobile terminal.

18. A telecommunication system for setting up a call for a short-code access number, wherein said system comprises:
(i) a predefined communication server
(ii) means for transmitting a short-code access number over a signaling channel from a mobile terminal to said communication server;
(iii) a database coupled to said communication server, wherein said database contains translation information from said short-code access numbers to full telephone numbers;
(iv) means for transmitting said full telephone number over a signaling channel from said communication server to said mobile terminal; and
(v) means for setting up a call from said mobile terminal to said full telephone number.

19. A telecommunication system according to claim 18, wherein said database contains short-code access numbers for different categories of entities.

20. A telecommunication system according to claim 19, wherein short-code access numbers are allocated to each of said different categories of entities according to a predefined order.

21. A telecommunication system according to claim 20, wherein each of said different categories of entities is allocated short-code access numbers with a predefined number of digits.

22. A telecommunication system according to claim 19, wherein said categories of entities are selected from the group consisting of: (i) real or virtual mobile operators, (ii) companies, commercial organizations, or non-commercial organizations, (iii) individual subscribers, and (iv) any combination of (i) to (iii).

23. A telecommunication system according to claim 22, wherein said category of entities is real or virtual mobile operators that are allocated short-code access numbers with 3 or 4 digits.

24. A telecommunication system according to claim 22, wherein said category of entities is companies, commercial organizations, or non-commercial organizations that are allocated short-code access numbers with 2 digits.

25. A telecommunication system according to claim 22, wherein said category of entities is individual subscribers that are allocated short-code access numbers with 1 digit.

26. A telecommunication system according to claim 18, wherein said short-codes database is updated, managed or modified by authorized users.

27. A telecommunication system according to claim 26, wherein said short-codes database is updated, managed and modified by authorized users via an external interface.

28. A telecommunication system according to claim 27, wherein said external interface is the Internet.

29. A telecommunication system according to claim 18, wherein said communication server receives information about the geographic location of said mobile terminal.

30. A telecommunication system according to claim 29, wherein a given short-code access number is translated into different full telephone numbers depending on the geographic location of said mobile terminal.

31. A telecommunication system according to claim 18, wherein said mobile terminal contains software or hardware logic adapted to transmit said short-code access number from said mobile terminal to said communication server over said signaling channel, to receive from said communication server the full telephone number translation of the short-code access number, and to establish a voice channel from said mobile terminal to said full telephone number.

32. A telecommunication system according to claim 31, wherein said software or hardware logic on the mobile terminal is placed within an attached memory device.

33. A telecommunication system according to claim 32, wherein said attached memory device is a Subscriber Identification Module (SIM) card.

34. A telecommunication system according to claim 31, wherein said software or hardware logic is downloaded from an external source.

35. A telecommunication system according to claim 34, wherein said external source is the Internet, a corporate network, a commercial network, a personal computer or a mobile terminal.
